(19) United States
(12) Patent Application Publication
(10) Pub. No.: US 2003/0090621 A1
(43) Pub. Date: May 15, 2003

(54) Clever frame/clip

(76) Inventor: Weizhen Chai, Montreal (CA)

Correspondence Address: Weizhen CHAI, #5325 Sherbrooke West, Apt 3, Montreal, QC, H4A 1V2, CA

(21) Appl. No.: 10/279,801

(22) Filed: Oct. 25, 2002

(30) Foreign Application Priority Data
Nov. 13, 2001 (CA) 2,363,059

(51) Int. Cl. G02C 5/14; G02C 5/22

(52) U.S. Cl. 351/153

(57) ABSTRACT

For the eyewear products, currently the most popular clip-on of sun glasses is the magnetic clip, which is non-reliable after using a period of time. It's also said the magnetic pieces would cause headache to some people. This invention is try to offer a reliable mechanic structure to the frame/clip to facilitate people who wear glasses.

### BACKGROUND OF THE INVENTION

These years magnetic easy frame/clip is very popular among people wearing glasses. Though easy to use when it's new, it'd become non-reliable after using a period of time. Also it's said the magnitic pieces would cause headache to some groups of people.

### BRIEF SUMMARY OF THE INVENTION

This invention is to offer a new frame/clip which is mechanic structure and easy to use, reliable while matching various kinds of styles of designs.

### BRIEF DESCRIPTION OF THE DRAWING

FIG. 1—the frame structure, which is observed frome above

FIG. 2—the half-free lock structure

FIG. 3—the locking pin of the clip

### DETAILED DESCRIPTION OF THE INVENTION

The invention is mainly comprised of following parts:

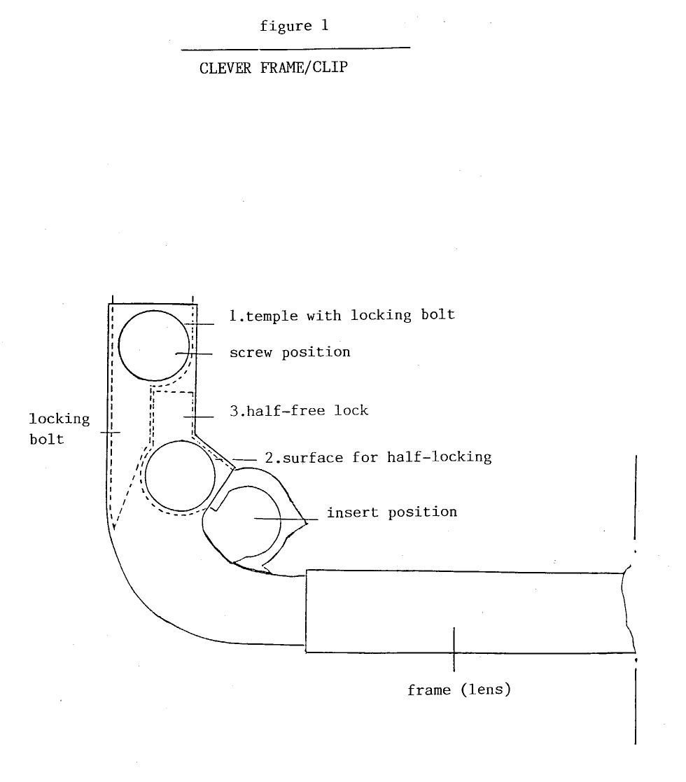

part 1. temple with locking bolt (see FIG. 1)

part 2. surface for half-locking (see FIG. 1);

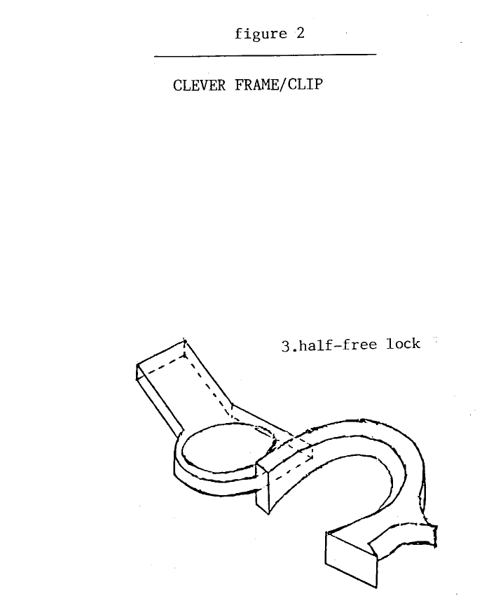

part 3. half-free lock (see FIG. 1 and FIG. 2);

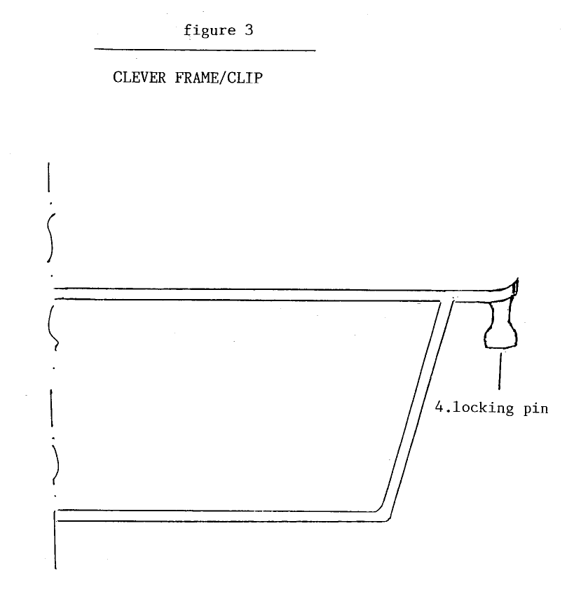

part 4. locking pin of the clip (see FIG. 3)

The above description includes the parts on one side, let's say, the right side covering the right eye. For the other side, the left side covering the left eye, the same parts would be at the same symmetrical positions.

When put to use, the user should do as following:

(1) Set the temple (part 1) at close position;

(2)Open the half-free lock (part 3)—(optional, as lock half-free, insert pin could also be simply pushed into the position)

(3)Insert part 4 into the insert position;

(4)Close the half-free lock (part 3)

(5)Then open part 1. When part 1 is opened (put-to-head position), the locking bolt of the temple would completely lock the half-free lock (part 3). Therefore when people wear their glasses, or when the temples were kept at opening positions, the clip would be firmly connected with the frame.

When people want to strip the clip off the frame, just close the temples(part 1), so that the locking bolt and the half-free lock is completely disconnected and the half-free lock is no longer locked(half-free). Then open the half-free lock (part 3) and take the clip-on off the frame (or just push the pin out of the insert position)

1. A frame/clip, comprising a pair of temples with locking bolt, a pair of half-free locks, locking surfaces, and locking pins of the clip.

2. A frame defined in claim 1, in which the locking bolts of the temples play the locking function to the clip by fixing the half-free locks

3. A frame defined in claim 1, in which the half-free locks fix the locking pins of the clip under the function of the locking bolts of the temples.

4. A clip defined in claim 1, in which the locking pins have a outer-shaped end.
